(19) United States
(12) Patent Application Publication
(10) Pub. No.: US 2024/0320032 A1
(43) Pub. Date: Sep. 26, 2024

(54) SYSTEMS AND METHODS FOR EXCHANGE OF DATA BETWEEN MICROSERVICES

(71) Applicant: ACCENTURE GLOBAL SOLUTIONS LIMITED, Dublin 4 (IE)

(72) Inventor: ZhongHua XU, Singapore (SG)

(73) Assignee: ACCENTURE GLOBAL SOLUTIONS LIMITED, Dublin 4 (IE)

(21) Appl. No.: 18/126,049

(22) Filed: Mar. 24, 2023

(51) Int. Cl. G06F 9/48

(52) U.S. Cl. CPC G06F 9/4881

(57) ABSTRACT

Systems and methods for exchanging data between a set of microservices are disclosed herein. A system may establish an event queue-based persistent connection between a set of microservices, where the set of microservices may include a requesting microservice and a providing microservice. Further, the system may receive a request in a queue of a plurality of requests from the requesting microservice, and retrieve, from the queue, a pre-determined number of requests based on a weighting score associated with each of the pre-determined number of requests. Furthermore, the system may process the pre-determined number of requests in parallel, generate a response to the received request based on the processing, and provide the generated response to the requesting microservice.

### BACKGROUND

Microservices are associated with a computing architecture that structures a single application/service as a collection of loosely coupled services. This allows each microservice that represents the single application/service to be independently deployed even when the overall single application/service is complex. Each microservice provides fine-grain functionality associated with a portion of the single application/service. Each microservice is loosely coupled to other microservices because the degree of dependence between the microservices associated the single application/service is small and substantially smaller than what is associated with the coupling/dependencies between the original functions of the original single application/service.

Enterprises are migrating their applications/services architectures and newly provided services to be provided to their customers over networks as microservices. One concern with microservices is the ability to achieve fast and efficient communication between the microservices. This is because what was previously a single/application or service executing on a single device will now be a collection of individual services each of which may be executing on different devices across a network. Therefore, microservice communications may span multiple devices over a network whereas a single monolithic application/service communicates within memory of a single device.

The problem with existing systems is that the microservice-to-microservice interface may not be efficient. There may be a need for microservices to access application programming interfaces (APIs) of other microservices in a synchronous manner. It may be inefficient to use hypertext transfer protocol representational state transfer API call or web socket connection to support inter-communication among microservices, because the process for the connection is slow, resource intensive, and costly for synchronous processing. Establishing a connection may require a lot of processing and resources like authentication, processor, memory, database connection, or the like, and this problem snowballs when there are many services that need to exchange data and many concurrent users.

There is, therefore, a need for systems and methods for addressing at least the above-mentioned problems in existing systems.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system including a processor, and a memory coupled to the processor. The memory includes processor-executable instructions, which on execution, cause the processor to establish an event queue-based persistent connection between a set of microservices, where the set of microservices may include at least a requesting microservice and a providing microservice, receive a request in a queue of a plurality of requests from the requesting microservice of the set of microservices, retrieve, from the queue, a pre-determined number of requests based on a weighting score associated with each of the pre-determined number of requests, where the pre-determined number of requests may include at least the received request, process the pre-determined number of requests in parallel, generate a response to the received request based on the processing, and provide the generated response to the requesting microservice.

In an example embodiment, the weighting score may be based on a priority associated with each request received from the set of microservices, where the priority is based at least on a type of the request, and a mode of the request.

In an example embodiment, the type of the request may include one of update and query, and the mode of the request may include one of a synchronous request and an asynchronous request.

In an example embodiment, the processor may provide the response to the synchronous request to the requesting microservice based on inserting the response in the queue. In an example embodiment, the processor may provide the response to the asynchronous request to the requesting microservice based on implementing a callback functionality using a message broker.

In an example embodiment, for each request received from the set of microservices, the processor may assign a set of metadata to the request, and sort the queue based on the assigned set of metadata.

In an example embodiment, the metadata may include at least one of a request identity (ID), a name of the requesting microservice, a request time, a request wait time, a response type, a priority, a pick up order, and a session ID.

In an example embodiment, the pick up order associated with the request may be based on the request wait time and the priority.

In an example embodiment, the processor may sort the queue based on the pick up order.

In an example embodiment, processor may retrieve the pre-determined number of requests by retrieving the requests associated with same requesting microservice and same session ID.

In an example embodiment, the processor may establish the event queue-based persistent connection by assigning an inter-communication port with each of the set of microservices, where each inter-communication port may be configured to register respective microservice of the set of microservices at a registration database.

In an example embodiment, the processor may process the received request by determining whether to switch to stream mode, in response to a positive determination, generating the response including a stream object identifier (ID), and performing data transmission between the requesting microservice and the providing microservice based on the stream object ID, and in response to a negative determination, generating the response based on a mode of the request.

In an aspect, the present disclosure relates to a method including establishing, by a processor, an event queue-based persistent connection between a set of microservices, where the set of microservices may include at least a requesting microservice and a providing microservice, receiving, by the processor, a request in a queue of a plurality of requests from the requesting microservice of the set of microservices, retrieving and processing, by the processor, from the queue, a pre-determined number of requests based on a weighting score associated with each of the pre-determined number of requests, where the pre-determined number of requests may include at least the received request, generating, by the processor, a response to the received request based on the processing, and providing, by the processor, the generated response to the requesting microservice.

In another aspect, the present disclosure relates to a non-transitory computer-readable medium comprising machine-readable instructions that are executable by a processor to perform the steps of the method described herein.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

FIG. 1A illustrates an operating environment or a network architecture 100-1 for exchange of data between a set of microservices.

FIG. 1B illustrates an operating environment or a network architecture 100-2 for exchange of data between a set of microservices, in accordance with embodiments of the present disclosure.

FIG. 2A illustrates an exemplary block diagram 200-1 comprising components for facilitating exchange of data between a set of microservices, in accordance with embodiments of the present disclosure.

FIG. 2B illustrates an example flow diagram 200-2 comprising components for facilitating exchange of data between a set of microservices, in accordance with embodiments of the present disclosure.

FIG. 3 illustrates an exemplary representation 300 of event queue for a plurality of microservices, in accordance with embodiments of the present disclosure.

FIG. 4 illustrates an example sequence flow diagram 400 for establishing a connection between a requesting microservice and a providing microservice, in accordance with embodiments of the present disclosure.

FIG. 5 illustrates an example flow diagram of a method 500 for implementing exchange of data between a set of microservices, in accordance with embodiments of the present disclosure.

FIG. 6 illustrates a computer system 600 in which or with which embodiments of the present disclosure may be implemented.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The present disclosure provides a system or a network architecture for implementing exchange of data between a set of microservices. With the proposed system, it may be easier for microservices to use the more efficient event-based synchronous communication via an always-connected interface and to switch to use stream mode only where data is large. The proposed system may also support asynchronous requests.

As an initial step, the system may establish an event queue-based persistent connection between a set of microservices. In an example embodiment, the set of microservices may include a requesting microservice and a providing microservice. In an example embodiment, the system may establish the event queue-based persistent connection by assigning an inter-communication module or port with each of the set of microservices, which may be controlled by an inter-communication controller.

The system may receive a request from the requesting microservice for another microservice, i.e. providing microservice. In an example embodiment, the system may push the received request in an event queue of a plurality of requests. The system may retrieve a pre-determined number of requests, including the request received from the requesting microservice, from the queue. In an example embodiment, the system may retrieve the requests based on a weighting score associated with each request. In an example embodiment, the weighting score may be based on a priority assigned to each request. The priority may be based on, but not limited to, a type and a mode of the request. In an example embodiment, the type of the request may include query and update, and the mode of the request may include synchronous and asynchronous. In an example embodiment, for each request received from the set of microservices, the system may assign a set of metadata to the request and sort the queue based on the assigned set of metadata. In an example embodiment, the set of metadata may include, but not be limited to, a request identity (ID), a name of the requesting microservice, a request time, a request wait time, a response type, a priority, a pick up order, and a session ID. The pick up order associated with the request may be based on the request wait time and the priority. In an example embodiment, the system may sort the queue based at least on the pick up order. Further, the system may retrieve the pre-determined number of requests by retrieving the requests associated with same requesting microservice and same session ID.

Further, the system may process the retrieved requests in parallel. In an example embodiment, the system may process the requests based on a type of the request, for example, synchronous or asynchronous. In another example embodiment, the system may determine whether to switch to stream mode to process the request based at least on the response size. In response to a positive determination, the system may generate the response and insert a stream object ID in the response and perform data transfer between the requesting microservice and the providing microservice based on establishing a direct connection. In response to a negative determination, the system may generate the response based on the mode of the request, i.e. synchronous or asynchronous. In case of a synchronous request, the system may provide the response to the requesting microservice based on inserting the response in the queue. In case of an asynchronous request, the system may provide the response to the requesting microservice based on implementing a call-back functionality using a message broker.

Therefore, the present disclosure provides an efficient manner of exchanging data between the set of microservices. As discussed herein and below, a “microservice” may refer to one or more functions/operations decoupled from a particular service. The particular service may comprise multiple functions/operations defined by multiple microservices cooperating with one another to provide the overall functions/operations of the particular service. The particular service may include, but not be limited to, a communications service, a transaction service, or the like. The particular service may be decomposed into loosely coupled operations that comprise the cooperating microservices. Each microservice may process on a same or different computing device from remaining ones of combinations of the microservices. Each device that processes one or more of the microservices may be a server, a virtual machine (VM), a container, the terminal where the particular service was initiated, or any other computing device. In this manner, the functions/operations of the particular service may be distributed by the cooperating microservices over multiple devices, a same device, or combinations of these. Furthermore, each microservice may natively execute on a same or different platform from remaining ones of the microservices. In this way, the microservices may be device and platform independent or agnostic.

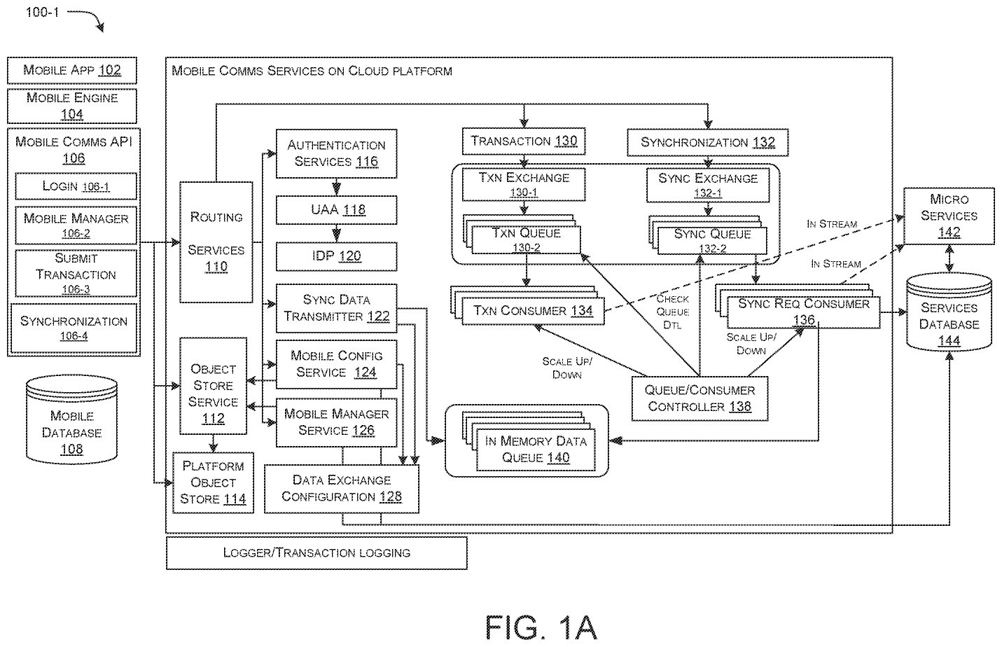

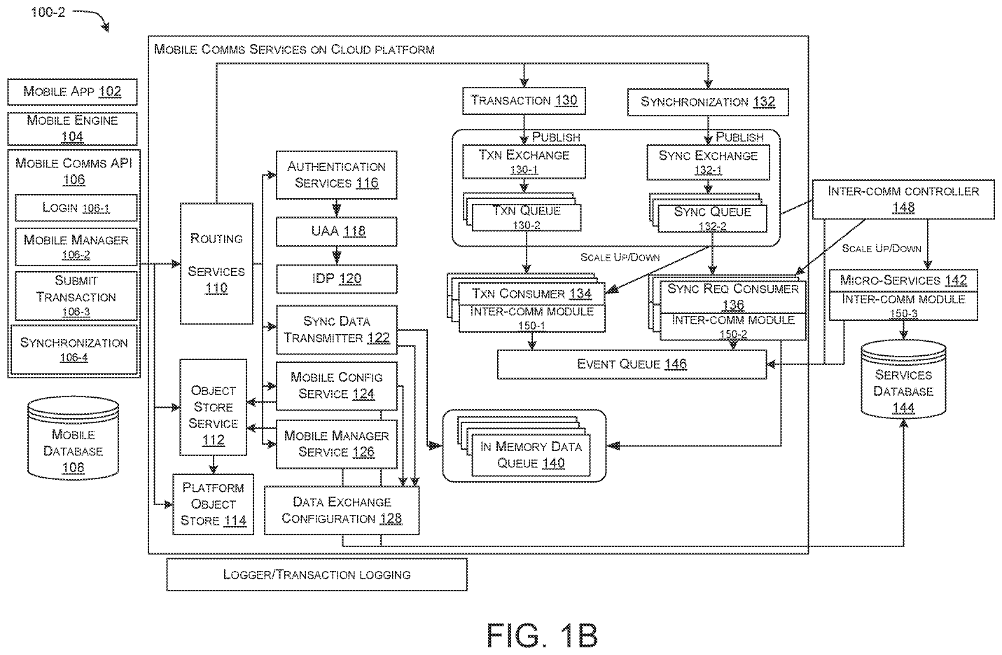

FIG. 1A illustrates an operating environment or a network architecture 100-1 for exchange of data between a set of microservices.

The network architecture 100-1 may include a mobile application 102, a mobile engine 104, one or more mobile communication application programming interfaces (APIs) 106, and a mobile database 108. Further, the network architecture 100-1 may include a cloud platform for mobile communication services, where transaction logging of microservices may take place. Furthermore, the network architecture 100-1 may include a set of microservices 142 along with a services database 144. The set of microservices 142 may be implemented on a distributor management system.

Referring to FIG. 1A, the cloud platform may include and/or implement one or more microservices using the set of microservices 142, for example, routing services 110, object store services 112, authentication services 116, synchronization data transmitter 122, mobile configuration services 124, mobile manager services 126, transaction services 130, synchronization services 132, queue/consumer controller 138, or the like. Further, the cloud platform may also include and/or implement one or more services including, but not limited to, platform object store 114, user account and authentication (UAA) services 118, and identity provider (IDP) 120. Furthermore, the cloud platform may implement a transaction exchange service 130-1 and a transaction queue 130-2 for transaction services 130, and a synchronization exchange service 132-1 and a synchronization queue 132-2 for synchronization services 132.

Referring to FIG. 1A, the network architecture 100-1 may include an in-memory queue 140 and a data exchange configuration 128. A request from the transaction queue 130-2 may go to a transaction consumer engine 134, and a request from the synchronization queue 132-2 may go to a synchronization request consumer engine 136.

The various embodiments throughout the disclosure will be explained in more detail with reference to FIGS. 1B-6.

FIG. 1B illustrates an operating environment or a network architecture 100-2 for exchange of data between a set of microservices, in accordance with embodiments of the present disclosure.

Referring to FIG. 1B, the network architecture 100-2 may correspond to the proposed system for implementing exchange of data between the set of microservices. The network architecture 100-2 may include components that are similar to those depicted in FIG. 1A, and few additional proposed components that may facilitate the exchange of data between the set of microservices, in accordance with embodiments of the present disclosure. For example, the network architecture 100-2 may include an inter-communication controller 148 that may control one or more inter-communication modules or ports (150-1, 150-2, 150-3). In an example embodiment, each of the one or more inter-communication modules or ports (150-1, 150-2, 150-3) may be configured with the transaction consumer module 134, the synchronization request consumer module 136, and the set of microservices 142. Further, the network architecture 100-2 may include an event queue 146.

Referring to FIG. 1B, the mobile engine 104 may run on any computing device executing on any operating system. The mobile engine 104 may provide a standard set of operating system agnostic functions required by the mobile application 102 to simplify application development, for example, related to communications, user interface, database, hardware, or the like. In an example embodiment, the mobile engine 104 may include the mobile communication APIs 106. The mobile communication APIs 106 are a set of APIs that may support mobile application development in order to use the proposed cloud platform for mobile communication services. In an example embodiment, the mobile communication APIs 106 may include, but not be limited to, login 106-1, mobile manager 106-2, submit transaction 106-3, synchronization 106-4, etc. In an example embodiment, the mobile engine 104 may include the mobile database 106 for data storage. In an example embodiment, the mobile application 102 may run on the mobile engine 104 and define user interface and logic based on requirements.

Referring to FIG. 1B, the cloud platform may implement a plurality of services such as, but not limited to, routing services 110, object store services 112, authentication services 116, synchronization data transmitter 122, mobile configuration services 124, mobile manager services 126, transaction services 130, synchronization services 132, and the like. In an example embodiment, the cloud platform may implement UAA services 118 for device user authentication and authorization. In an example embodiment, the routing services 110 may be the single entry point of mobile communication.

Referring to FIG. 1B, the transaction services 130 may process all transactions submitted by the mobile engine 104. The transactions may be pushed to the transaction queue 130-2, and a response may be sent to the mobile engine 104. In an example embodiment, the transaction consumer services 134 may process the transactions from the transaction queue 130-2. The transaction consumer services 134 may check if there is transaction data available in the transaction queue 130-2 for processing. Based on the checking, the transaction consumer services 134 may load the corresponding processing logic configuration of the transaction and process the transaction accordingly. In an example embodiment, the processing of the transaction may include, but not be limited to, record existence checking, data mapping, and data conversion. The transaction consumer services 134 may support extra logic handlers by calling external microservices, for example, the microservices 142. In an example embodiment, the transaction consumer services 134 may insert transaction data into the event queue 146 if there is additional processing required. In an example embodiment, the transaction consumer services 134 may call the microservices (for example, the distributer management system) 142 which may handle business logic as post process actions. This way, the transaction consumer services 134 may complete the processing of the transaction and move on to the next transaction from the transaction queue 130-2.

In an example embodiment, the synchronization services 132 may handle all mobile data synchronization requests. In an example embodiment, the synchronization services 132 may load manifest from the in-memory data queue 140. The manifest may include, but not be limited to, method, data source, and group information of the synchronization. Further, the synchronization services 132 may separate a synchronization task into groups such as, but not limited to, production, customer, key performance indicator (KPI), or the like. The synchronization services 132 may then load or publish group data requests into specific exchange 132-1 or queues 132-2 of a message broker based at least on hash value of mobile hardware ID for load distribution. In an example embodiment, based on receiving the group data requests, the synchronization request consumer services 136 may call multiple microservices 142 simultaneously, establish representational state transfer (REST) API, and receive data in stream. After data formatting and grouping the data in stream, the synchronization services 136 mat store synchronization data in the in-memory data queue 140.

In an example embodiment, the mobile engine 104 may request the synchronization data with current message ID. In such a scenario, the synchronization data transmitter 122 may get the synchronization data from the in-memory data queue 140 and transfer the synchronization data back to the mobile engine 104 in stream. In case of a connection breakup or error, the synchronization data transmitter 122 may resume data transfer upon break point. When all the synchronization data is sent to the mobile engine 104, a final response with new data version may be sent to the mobile engine 104.

Therefore, the proposed architecture 100-2 may use the event queue 146 in accordance with the inter-communication controller 148 and the one or more inter-communication modules (150-1, 150-2, 150-3) to facilitate the exchange of data between the set of microservices. The proposed architecture 100-2 provides an efficient interface between the set of microservices to enable event-based synchronous communication and may switch to use stream only when the data is large. In an example embodiment, the proposed architecture 100-2 may also enable asynchronous communication where required.

Although FIG. 1B shows exemplary components of the network architecture 100-2, in other embodiments, the network architecture 100-2 may include fewer components, different components, differently arranged components, or additional functional components than depicted in FIG. 1B. Additionally, or alternatively, one or more components of the network architecture 100-2 may perform functions described as being performed by one or more other components of the network architecture 100-2.

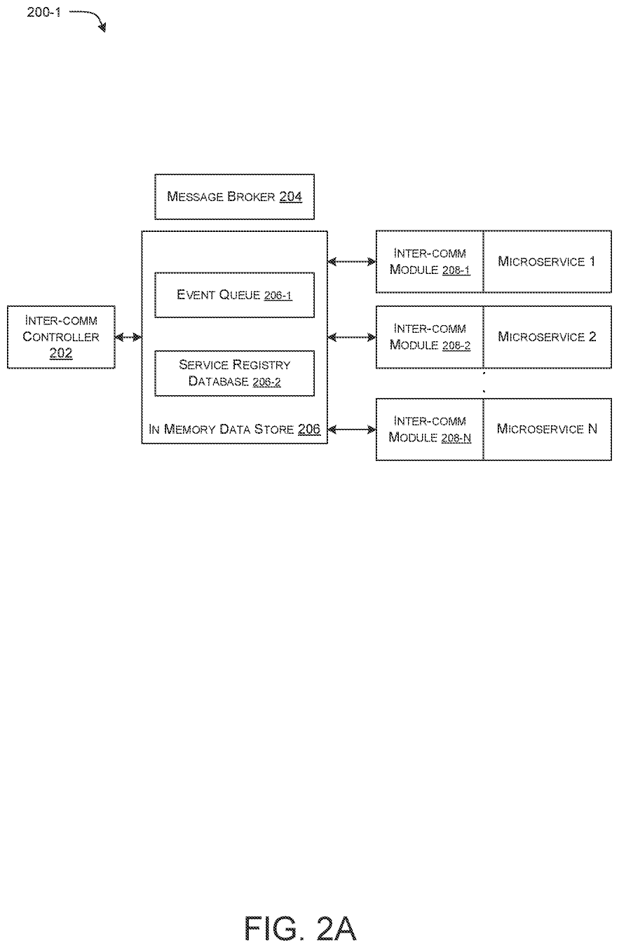

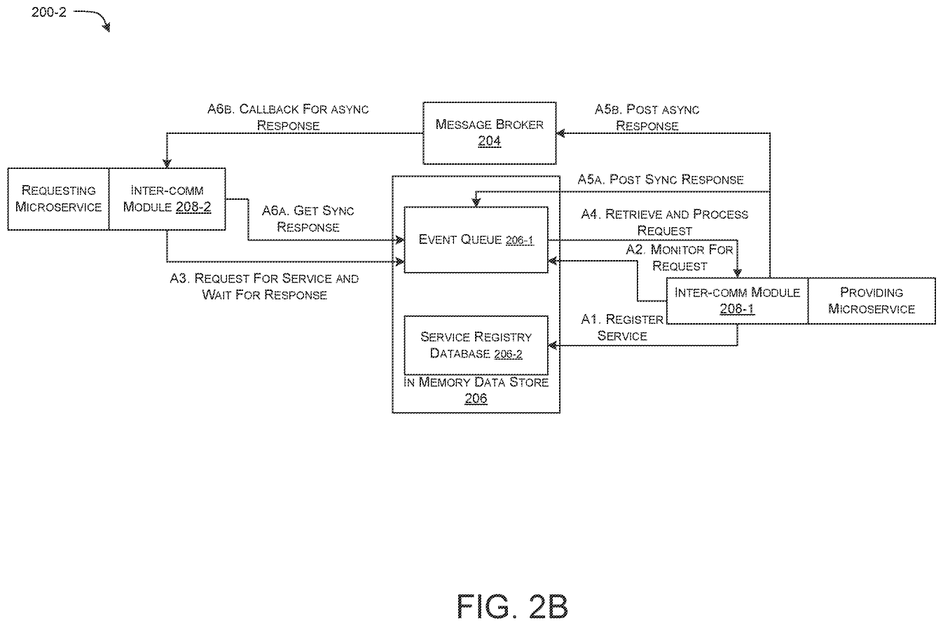

FIG. 2A illustrates an exemplary block diagram 200-1 comprising components for facilitating exchange of data between a set of microservices, in accordance with embodiments of the present disclosure.

Referring to FIG. 2A, the exemplary block diagram 200-1 may include an inter-communication controller 202, a message broker 204, an in-memory data store 206 comprising an event queue 206-1 and a service registry database 206-2, and a set of microservices. In an example embodiment, each of the set of microservices may be configured with an inter-communication module or port, for example, microservice 1 with a first inter-communication module 208-1, microservice 2 with a second inter-communication module 208-2, and microservice N with N^{th} inter-communication module 208-N. A person of ordinary skill in the art will understand that the one or more inter-communication modules (208-1, 208-2 . . . 208-N) may be individually referred as the inter-communication module 208 and collectively referred as the inter-communication modules 208. Further, it may be appreciated that the inter-communication controller 202, the in-memory data store 206, and the inter-communication modules (208-1, 208-2 . . . 208-N) may be similar to the respective inter-communication controller 148, the in-memory data queue 140, and the inter-communication modules (150-1, 150-2, 150-3) of FIG. 1B in their functionality.

Referring to FIG. 2A, the inter-communication controller 202 may refer to a microservice API that may be responsible for managing events.

In an example embodiment, the inter-communication modules 208 may refer to a library configured with each microservice. The inter-communication modules 208 may perform registration of each microservice at the service registry database 206-2 with regular keep alive mechanism, and create request and response queues such as the event queue 206-1. Further, the inter-communication modules 208 associated with one microservice may request for service from another microservice.

In an example embodiment, the event queue 206-1 may have multiple queues, for example, a request queue and a response queue. In an example embodiment, the service registry database 206-2 may enable registration of the set of microservices and instances including, but not limited to, maintaining status, API statistics, scale up/down monitoring, etc.

As discussed with reference to FIG. 1B, the proposed system may support both synchronous and asynchronous requests. In an example embodiment, for synchronous requests, the microservices may monitor the response queue (i.e. the event queue 206-1) for a response. In another example embodiment, for asynchronous requests, the microservices may wait for a callback, which may be implemented using the message broker 204.

Referring to FIG. 2A, the inter-communication controller 202 may monitor the registration of the microservices at the service registry database 206-2 and the event queue 206-1 to ensure that the microservices are active and running. Further, the inter-communication controller 202 may restart the microservices that may not be responding. In an example embodiment, the inter-communication controller 202 may scale up and/or down the microservices based on configuration and status of the microservices. In case the event queue 206-1 builds up, the inter-communication controller 202 may start additional instances to handle the load and shut down idle instances. Further, the inter-communication controller 202 may console for configuration and report version, processor or memory usage, number of instances of microservices, and other such statistics.

Referring to FIG. 2A, the inter-communication modules 208 may modify the data retrieval process to improve efficiency without having any effect on the microservices. For example, the inter-communication modules 208 may change the in-memory data store 206 or the message broker 204 based on a type of request. Further, the inter-communication modules 208 may perform data caching to reduce the impact of requestor making repeated calls in a short time span. Furthermore, based on the configuration, the requestor may flag the type of the response as stream in the response type of the request, and the requestor may build or establish a direct stream connection to a provider to get data.

Although FIG. 2A shows exemplary components of the block diagram 200-1, in other embodiments, the block diagram 200-1 may include fewer components, different components, differently arranged components, or additional functional components than depicted in FIG. 2A. Additionally, or alternatively, one or more components of the block diagram 200-1 may perform functions described as being performed by one or more other components of the block diagram 200-1.

FIG. 2B illustrates an example flow diagram 200-2 comprising components from FIG. 2A for facilitating exchange of data between a set of microservices, in accordance with embodiments of the present disclosure.

Referring to FIG. 2B, at step A1, a providing microservice may register the respective service at the service registry database 206-2 in the in-memory data store 206. In an example embodiment, the inter-communication module 208-1 associated with the providing microservice may register the providing microservice at the service registry database 206-2.

Further, at step A2, the providing microservice and/or the inter-communication module 208-1 may monitor the event queue 206-1 for requests from another microservice such as a requesting microservice. In an example embodiment, at step A3, the requesting microservice may request for service at the event queue 206-1 and wait for a response. In such a scenario, the inter-communication module 208-2 associated with the requesting microservice may insert the request in the event queue 206-1.

In an example embodiment, requests from requesting microservices may be inserted and associated with a set of metadata in the event queue 206-1. In an example embodiment, the requests may be inserted in the event queue 206-1 by time. The set of metadata may include, but not be limited to, a request ID, a name of the requesting microservice, a request time, a request wait time, a response type, a priority, a pick up order, and a session ID. For example, table 1 shows a plurality of requests associated with the set of metadata.

TABLE 1

| Request | | Pickup | Micro | |
|---|---|---|---|---|
| Wait Time | Priority | Order | Service | Session ID |
| 1 | 30 | 30 | A | A1 |
| 2 | 10 | 20 | A | A2 |
| 3 | 10 | 30 | A | A2 |
| 4 | 20 | 80 | B | B1 |
| 5 | 10 | 50 | A | A2 |
| 6 | 20 | 120 | C | C1 |
| 7 | 10 | 70 | D | D1 |
| 8 | 10 | 80 | D | D1 |

Further, in an example embodiment, the event queue 206-1 may be sorted based on the pick up order. The pick up order may be based on the request wait time and the priority. Specifically,

Pick up order=Request wait time*Priority

Table 2 shows sorting of the event queue based on the pick up order.

TABLE 2

| Request | | Pickup | Micro | |
|---|---|---|---|---|
| Wait Time | Priority | Order | Service | Session ID |
| 2 | 10 | 20 | A | A2 |
| 1 | 30 | 30 | A | A1 |
| 3 | 10 | 30 | A | A2 |
| 5 | 10 | 50 | A | A2 |
| 7 | 10 | 70 | D | D1 |
| 4 | 20 | 80 | B | B1 |
| 8 | 10 | 80 | D | D1 |
| 6 | 20 | 120 | C | C1 |

Referring to FIG. 2B, at step A4, the inter-communication module 208-1 associated with the providing microservice may retrieve the request from the event queue 206-1 and process the request accordingly. In an example embodiment, the inter-communication module 208-1 may retrieve a pre-determined number of requests from the event queue 206-1 based on a weighting score associated with each of the pre-determined number of requests. In such an embodiment, the pre-determined number of requests may include the request from the requesting microservice. In an example embodiment, the pre-determined number of requests to be retrieved may be configurable for each microservice based on a complexity of its functionality. In an example embodiment, a default number of five requests may be retrieved from the event queue 206-1.

In an example embodiment, the weighting score may include assigning a priority to each request received from the requesting microservice. For example, the in-memory data store 206 may maintain a table such as table 3 shown below, for configuration of the priority for each type of request.

TABLE 3

| Priority | Synchronous | Asynchronous |
|---|---|---|
| Query (Get) | 10 | 30 |
| Update (Post) | 20 | 40 |

Each request may be assigned a priority based on a type of the request and a mode of the request. In an example embodiment, the type of the request may include, but not be limited to, query and update. In an example embodiment, the mode of the request may include synchronous request and asynchronous request. As an example but not limitation, for communication services, the query request may have a higher priority than update request, and the synchronous request may have a higher priority than the asynchronous request.

In an example embodiment, the providing microservice and/or the inter-communication module 208-1 may retrieve the requests from the event queue 206-1 that may be associated with same microservice and same session ID in order to enable requests of one session to be completed together to run the session to completion. For the event queue shown in Table 2, the inter-communication module 208-1 associated with the providing microservice may pick up requests 2, 3, and 5 because these requests are associated with the same microservice A and the same session ID A2. Thereafter, the inter-communication module 208-1 may pick up requests 1 and 7. After that, Table 4 shows the pending event queue.

TABLE 4

| Request | | Pickup | Micro | |
|---|---|---|---|---|
| Wait Time | Priority | Order | Service | Session ID |
| 4 | 1 | 4 | B | B1 |
| 6 | 2 | 12 | C | C1 |
| 8 | 1 | 8 | D | D1 |

If no new requests are added in the event queue 206-1, the next pick up may be the remaining three requests. In an example embodiment, if there are new requests, the new requests may be appended to the event queue 206-1 with calculated pick up order. For the next pick up, the event queue 206-1 may again be sorted based on the associated set of metadata.

Referring to FIG. 2B, in an example embodiment, the inter-communication module 208-1 may process the retrieved request based on a mode of the request. In case the mode of the request is synchronous, the inter-communication module 208-1 may post a response to the synchronous request in the event queue 206-1 at step A5a. The inter-communication module 208-2 associated with the requesting microservice may get the synchronous response from the event queue 206-1 at step A6a. In another example embodiment, in case the mode of the request is asynchronous, the inter-communication module 208-1 may post a response to the asynchronous request at the message broker 204 at step A5b. In such a case, the inter-communication module 208-2 associated with the requesting microservice may wait for a call-back functionality being implemented by the message broker 204. For example, at step A6b, the message broker 204 may call-back for the asynchronous response.

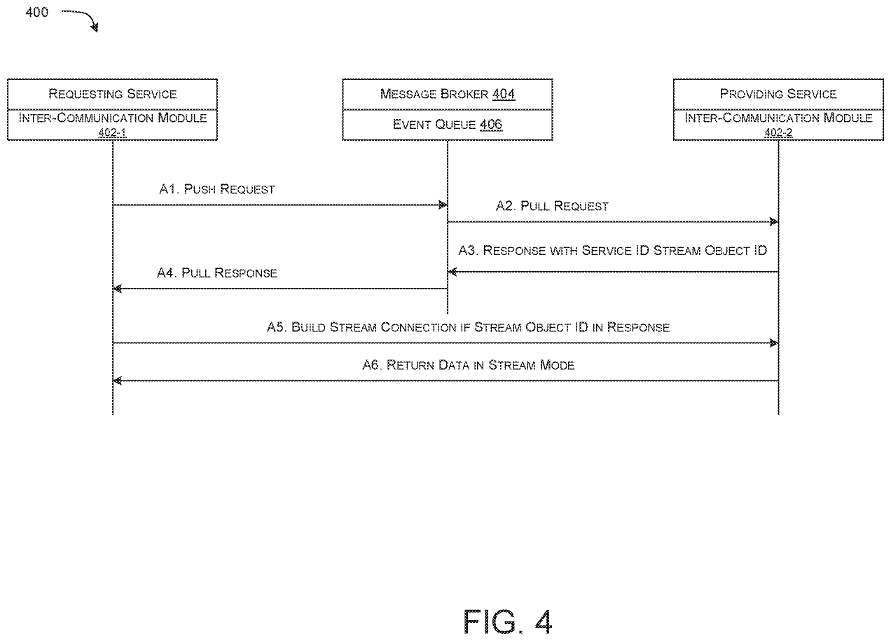

In an example embodiment, in case it is determined that the response type is stream, the providing microservice and/or the inter-communication module 208-1 associated with the providing microservice may insert a stream object ID in the response. Based on receiving the response, i.e. the stream object ID in the response, the requesting microservice (or, the inter-communication module 208-2) may establish a direct stream connection with the providing microservice (or, the inter-communication module 208-1) and perform data transfer. This may be explained in more detail with reference to FIG. 4 below.

Referring to FIG. 2B, the proposed system may implement the below function to handle empty queue event:
Set queue start time with current system time

Further, the proposed system may implement the below function to insert a new request:

Calculate request wait time=Request insert time−Queue start time

Calculate pick up order=Request wait time*Priority
Insert new request to the event queue

Furthermore, the proposed system may implement the following function to pick up a pre-determined number (N) of requests:
Sort outstanding requests in event queue by pick up order
Pick up=[ ]
While size (pick up)<N and request in queue>0
   Get the next outstanding request A based on pick up order
   Append request A into pick up array
   Session ID=session ID of request A
   Get all outstanding requests of the same session ID and append to pick up array

In an example embodiment, the providing microservice (or, the inter-communication module 208-1) may pick up more than the pre-determined number of requests (N) if there are more requests from the same session ID.

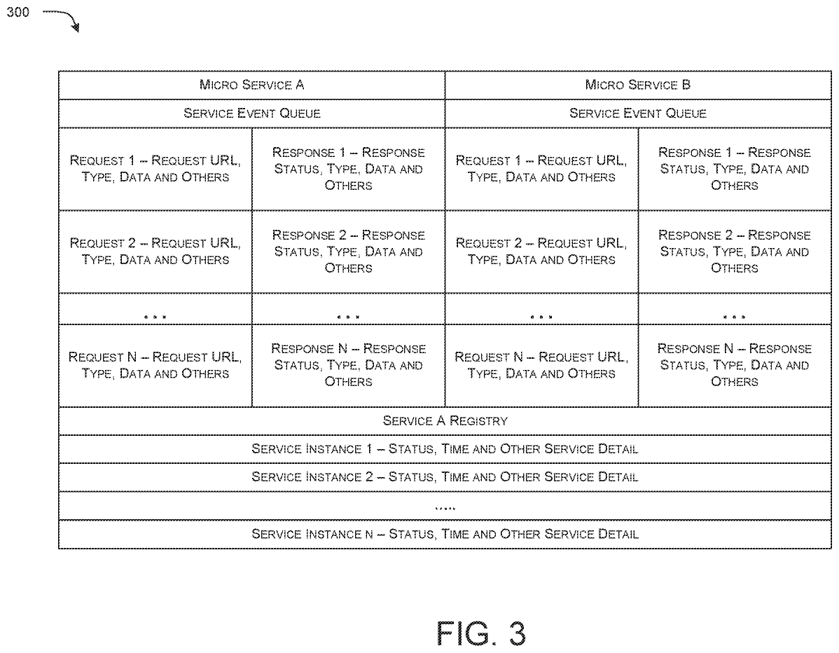

Referring to FIG. 2B, in an example embodiment, each microservice may have its own entry in the in-memory data store 206 for event queue 206-1 and service registry database 206-2. The requesting microservice may call the inter-communication module 208-2 to push the request into the event queue 206-1 of the providing microservice. Further, the providing microservice may process the request(s) in its event queue 206-1 and push the response into the event queue 206-1 for synchronous mode, or push the response into the message broker 204 for asynchronous mode. FIG. 3 illustrates an exemplary representation 300 of event queue being maintained for a plurality of microservices such as microservice A and microservice B.

FIG. 4 illustrates an example sequence flow diagram 400 for establishing a connection between a requesting microservice and a providing microservice, in accordance with embodiments of the present disclosure.

Referring to FIG. 4, at step A1, an inter-communication module 402-1 associated with a requesting microservice may push a request for another microservice at an event queue 406. It may be appreciated that the inter-communication module 402-1 and the event queue 406 may be similar to the respective inter-communication module 208-2 and the event queue 206-1 of FIG. 2B in their functionality.

At step A2, an inter-communication module 402-2 associated with a providing microservice may pull the request from the event queue 406. It may be appreciated that the inter-communication module 402-2 may be similar to the inter-communication module 208-1 of FIG. 2B in its functionality. In an example embodiment, the inter-communication module 402-2 may process the request based on a type and a mode of the request. In an example embodiment, the inter-communication module 402-2 may check whether to switch to stream mode based on the size of the response. Based on the checking, the inter-communication module 402-2 may queue stream object on stream mode. In such a scenario, the inter-communication module 402-2 may send a response to the event queue 406 with service ID and stream object ID at step A3.

Referring to FIG. 4, at step A4, the requesting service may pull the response from the event queue 406. If the response contains the stream object ID, the inter-communication module 402-1 may build a stream connection with the inter-communication module 402-2, at step A5. Further, at step A6, the providing service may return data to the requesting microservice in stream mode.

Therefore, the stream mode may make the data transmission more efficient with less memory consumption.

It may be appreciated that the steps shown in FIG. 4 are merely illustrative. Other suitable steps may be used to implement the stream mode communication, if desired. Moreover, the steps of the method 400 may be performed in any order and may include additional steps.

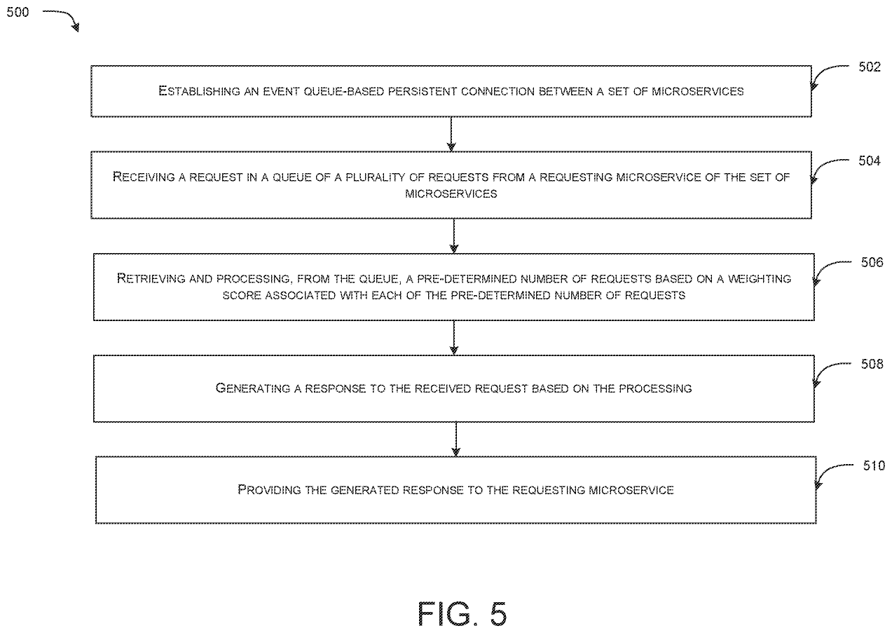

FIG. 5 illustrates an example flow diagram of a method 500 for implementing exchange of data between a set of microservices, in accordance with embodiments of the present disclosure.

Referring to FIG. 5, at step 502, the method 500 may include establishing an event queue-based persistent connection between a set of microservices. In an example embodiment, the set of microservices may include a requesting microservice and a providing microservice. Further, in an example embodiment, the method 500 may include assigning an inter-communication module or port configured to register respective microservice of the set of microservices at a service registry database. In an example embodiment, an inter-communication controller may control the inter-communication modules.

Further, at step 504, the method 500 may include receiving a request in a queue of a plurality of requests from the requesting microservice of the set of microservices. At step 506, the method 500 may include retrieving and processing, from the queue, a pre-determined number of requests based on a weighting score associated with each of the pre-determined number of requests. In an example embodiment, the pre-determined number of requests may include at least the received request. In an example embodiment, the method 500 may include processing the retrieved requests in parallel. Further, the weighting score may be based on a priority associated with each request received from the set of microservices. In an example embodiment, the priority may be based on, but not limited to, a type of the request, and a mode of the request. The type of the request may include, but not be limited to, update and query. The mode of the request may include, but not be limited to, a synchronous request and an asynchronous request. In an example embodiment, for each request received from the set of microservices, the method 500 may include assigning a set of metadata to the request and sorting the queue based on the assigned set of metadata. The set of metadata may include, but not be limited to, a request ID, a name of the requesting microservice, a request time, a request wait time, a response type, a priority, a pick up order, and a session ID. The pick up order may be based on the request wait time and the priority. In an example embodiment, the method 500 may include sorting the queue based on the pick up order. In another example embodiment, the method 500 may include retrieving the pre-determined number of requests from the queue that are associated with same requesting microservice and are associated with same session ID.

Referring to FIG. 5, at step 508, the method 500 may include generating a response to the request based on the processing. In an example embodiment, if the request is a synchronous request, the method 500 may include providing the response to the synchronous request based on inserting the response in the queue. In another example embodiment, if the request is an asynchronous request, the method 500 may include providing the response to the asynchronous request based on implementing a callback functionality using a message broker. In an example embodiment, the method 500 may include determining whether to switch to stream mode for generating the response to the request based on the request type and response size. In response to a positive determination, the method 500 may include generating the response by inserting a stream object ID in the response and performing data transfer or transmission between the requesting microservice and the providing microservice based on the stream object ID. In response to a negative determination, the method 500 may include generating the response based on the type and/or mode of the request.

Referring to FIG. 5, at step 510, the method 500 may include providing the generated response to the requesting microservice.

A person of ordinary skill in the art will readily ascertain that the illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

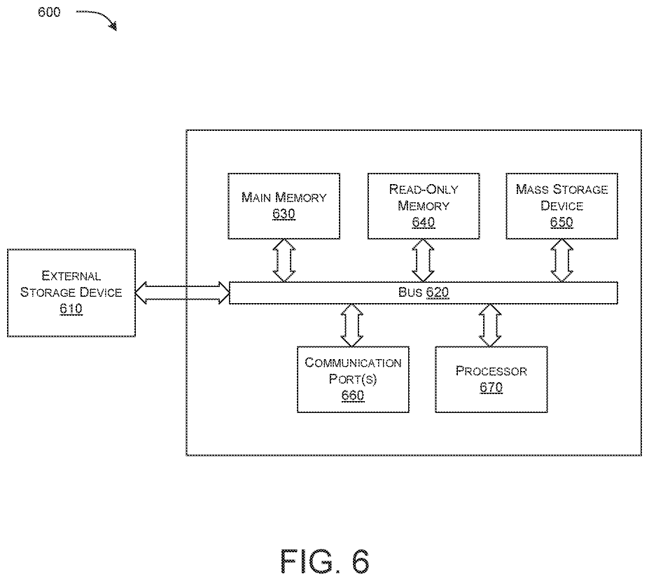

FIG. 6 illustrates a computer system 600 in which or with which embodiments of the present disclosure may be implemented. In particular, one or more components of the proposed network architecture 100-2, i.e. inter-communication controller and inter-communication module may be implemented as the computer system 600.

Referring to FIG. 6, the computer system 600 may include an external storage device 610, a bus 620, a main memory 630, a read-only memory 640, a mass storage device 650, communication port(s) 660, and a processor 670. A person skilled in the art will appreciate that the computer system 600 may include more than one processor and communication ports. The communication port(s) 660 may be any of an RS-232 port for use with a modem-based dialup connection, a 10/100 Ethernet port, a Gigabit or 10 Gigabit port using copper or fiber, a serial port, a parallel port, or other existing or future ports. The communication port(s) 660 may be chosen depending on a network, such a Local Area Network (LAN), Wide Area Network (WAN), or any network to which the computer system 600 connects. The main memory 630 may be random access memory (RAM), or any other dynamic storage device commonly known in the art. The memory 630 may be configured to store one or more computer-readable instructions or routines in a non-transitory computer-readable storage medium, which may be fetched and executed to facilitate exchange of data between a set of microservices.

The read-only memory 640 may be any static storage device(s) including, but not limited to, a Programmable Read Only Memory (PROM) chips for storing static information e.g., start-up or basic input/output system (BIOS) instructions for the processor 670. The mass storage device 650 may be any current or future mass storage solution, which may be used to store information and/or instructions. The bus 620 communicatively couples the processor 670 with the other memory, storage, and communication blocks. The processor 670 may be implemented as one or more microprocessors, microcomputers, microcontrollers, edge or fog microcontrollers, digital signal processors, central processing units, logic circuitries, and/or any devices that process data based on operational instructions. Among other capabilities, the processor 670 may be configured to fetch and execute computer-readable instructions stored in the memory 630. In an example embodiment, the processor 670 may execute the steps of the methods described herein.

The bus 620 may be, e.g. a Peripheral Component Interconnect (PCI)/PCI Extended (PCI-X) bus, Small Computer System Interface (SCSI), universal serial bus (USB), or the like, for connecting expansion cards, drives, and other subsystems as well as other buses, such a front side bus (FSB), which connects the processor 670 to the computer system 600. Optionally, operator and administrative interfaces, e.g. a display, keyboard, and a cursor control device, may also be coupled to the bus 620 to support direct operator interaction with the computer system 600. Other operator and administrative interfaces may be provided through network connections connected through the communication port(s) 660. In no way should the aforementioned exemplary computer system limit the scope of the present disclosure.

One of ordinary skill in the art will appreciate that techniques consistent with the present disclosure are applicable in other contexts as well without departing from the scope of the disclosure.

What has been described and illustrated herein are examples of the present disclosure. The terms, descriptions, and figures used herein are set forth by way of illustration only and are not meant as limitations. Many variations are possible within the spirit and scope of the subject matter, which is intended to be defined by the following claims and their equivalents in which all terms are meant in their broadest reasonable sense unless otherwise indicated.

1. A system, comprising:
a processor, and
a memory coupled to the processor, wherein the memory comprises processor-executable instructions, which when executed by the processor, cause the processor to:
establish an event queue-based persistent connection between a set of microservices, wherein the set of microservices comprises at least a requesting microservice and a providing microservice;
receive a request in a queue of a plurality of requests from the requesting microservice of the set of microservices;
retrieve, from the queue, a pre-determined number of requests based on a weighting score associated with each of the pre-determined number of requests, wherein the pre-determined number of requests comprises at least the received request;
process the pre-determined number of requests in parallel;
generate a response to the received request based on the processing; and
provide the generated response to the requesting microservice.

2. The system of claim 1, wherein the weighting score is based on a priority associated with each request received from the set of microservices, and wherein the priority is based at least on: a type of the request, and a mode of the request.

3. The system of claim 2, wherein the type of the request comprises one of: query and update, and wherein the mode of the request comprises one of: a synchronous request and an asynchronous request.

4. The system of claim 3, wherein the processor is to provide the response to the synchronous request to the requesting microservice based on inserting the response in the queue.

5. The system of claim 3, wherein the processor is to provide the response to the asynchronous request to the requesting microservice based on implementing a callback functionality using a message broker.

6. The system of claim 1, wherein, for each request received from the set of microservices, the processor is to:
assign a set of metadata to the request; and
sort the queue based on the assigned set of metadata.

7. The system of claim 6, wherein the metadata comprises at least one of: a request identity (ID), a name of the requesting microservice, a request time, a request wait time, a response type, a priority, a pick up order, and a session ID.

8. The system of claim 7, wherein the pick up order associated with the request is based on the request wait time and the priority.

9. The system of claim 8, wherein the processor is to sort the queue based on the pick up order.

10. The system of claim 9, wherein the processor is to retrieve the pre-determined number of requests by retrieving the requests associated with same requesting microservice and same session ID.

11. The system of claim 1, wherein the processor is to establish the event queue-based persistent connection by assigning an inter-communication port with each of the set of microservices, and wherein each inter-communication port is configured to register respective microservice of the set of microservices at a registration database.

12. The system of claim 1, wherein the processor is to process the received request by:
determining whether to switch to stream mode;
in response to a positive determination:
generating the response comprising a stream object identifier (ID); and
performing data transmission between the requesting microservice and the providing microservice based on the stream object ID; and
in response to a negative determination, generating the response based on a mode of the request.

13. A method, comprising:
establishing, by a processor, an event queue-based persistent connection between a set of microservices, wherein the set of microservices comprises at least a requesting microservice and a providing microservice;
receiving, by the processor, a request in a queue of a plurality of requests from the requesting microservice of the set of microservices;
retrieving and processing, by the processor, from the queue, a pre-determined number of requests based on a weighting score associated with each of the pre-determined number of requests, wherein the pre-determined number of requests comprises at least the received request;
generating, by the processor, a response to the received request based on the processing; and
providing, by the processor, the generated response to the requesting microservice.

14. The method of claim 13, wherein the weighting score comprises a priority associated with each request received from the set of microservices, and wherein the priority is based at least on: a type of the request, and a mode of the request.

15. The method of claim 14, wherein the type of the request comprises one of: update and query, and wherein the mode of the request comprises one of: a synchronous request and an asynchronous request.

16. The method of claim 15, comprising providing, by the processor, the response to the synchronous request to the requesting microservice based on inserting the response in the queue.

17. The method of claim 15, comprising providing, by the processor, the response to the asynchronous request to the requesting microservice based on implementing a callback functionality using a message broker.

18. The method of claim 13, wherein, for each request received from the set of microservices, the method comprises:
assigning, by the processor, a set of metadata to the request, wherein the metadata comprises at least one of: a request identity (ID), a name of the requesting microservice, a request time, a request wait time, a response type, a priority, a pick up order, and a session ID; and
sorting, by the processor, the queue based on the pick up order.

19. The method of claim 18, comprising retrieving and processing, by the processor, the pre-determined number of requests by retrieving the requests associated with same requesting microservice and same session ID.

20. A non-transitory computer-readable medium comprising machine-executable instructions that cause a processor to:
establish an event queue-based persistent connection between a set of microservices, wherein the set of microservices comprises at least a requesting microservice and a providing microservice;
receive a request in a queue of a plurality of requests from the requesting microservice of the set of microservices;
retrieve, from the queue, a pre-determined number of requests based on a weighting score associated with each of the pre-determined number of requests, wherein the pre-determined number of requests comprises at least the received request;
process the pre-determined number of requests in parallel;
generate a response to the received request based on the processing; and
provide the generated response to the requesting microservice.
